(19) United States
(12) Patent Application Publication
(10) Pub. No.: US 2002/0076093 A1
(43) Pub. Date: Jun. 20, 2002

(54) Method of processing a check and an apparatus therefor

(76) Inventors: Teresa J. Palmer, Waterloo (CA); Steven J. Palmer, Waterloo (CA)

Correspondence Address: Michael Chan, Intellectual Property Section, Law Department, NCR corporation, 101 West Schantz, ECD-2, Dayton, OH, 45479-0001, US

(21) Appl. No.: 09/736,744

(22) Filed: Dec. 14, 2000

(51) Int. Cl. G06K 9/00

(52) U.S. Cl. 382/137

(57) ABSTRACT

A method of processing a check without human intervention to determine if the check has a stale date comprises the steps of (a) extracting date data from a date field of the check, and (b) validating the extracted date data to determine if the extracted date data is representative of a date which is prior to a predetermined date and thereby to determine if the date data in the date field of the check is representative of a date which is stale. Preferably, step (b) includes the step of (b-1) comparing the extracted date data with date data which is representative of the predetermined date. The method may be at a check processing transport, a bank teller station, or an automated teller machine.

### BACKGROUND OF THE INVENTION

The present invention relates to check processing, and is particularly directed to a method of processing a check and an apparatus therefor.

A typical check has a number of fields including a payor field, a date field, a payee field, a courtesy amount field, a legal amount field, and a signature field. The check may be of the personal type or of the business type. Under current check handling rules, a check that is cashed more than a predetermined amount of time from the date contained in the date field of the check (i.e., a check with a “stale date”) is considered to be non-negotiable. A teller at a point of acceptance or personnel at a bank branch usually verifies the date contained in the date field of the check to determine if the check has a stale date. It would be desirable to provide an improved way of determining if a check has a stale date.

### SUMMARY OF THE INVENTION

In accordance with one aspect of the present invention, a method of processing a check without human intervention to determine if the check has a stale date comprises the steps of (a) extracting date data from a date field of the check, and (b) validating the extracted date data to determine if the extracted date data is representative of a date which is prior to a predetermined date and thereby to determine if the date data in the date field of the check is representative of a date which is stale. Preferably, step (b) includes the step of (b-1) comparing the extracted date data with date data which is representative of the predetermined date.

In accordance with another aspect of the present invention, a check processing apparatus comprises means for extracting date data from a date field of a check, and means for validating the extracted date data to determine if the extracted date data is representative of a date which is prior to a predetermined date and thereby to determine if the date data in the date field of the check is representative of a date which is stale. Preferably, the validating means includes means for comparing the extracted date data with date data which is representative of the predetermined date. The apparatus may further comprise a check processing transport including an image capture subsystem for capturing images of checks, a document transport mechanism for receiving checks hand dropped by a bank teller at a bank teller station, or a cash dispenser for dispensing cash to a customer of an automated teller machine.

In accordance with yet another aspect of the present invention, a program storage medium is readable by a computer having a memory. The medium tangibly embodies one or more programs of instructions executable by the computer to perform method steps for processing a check to determine if the check has a stale date. The method comprises the steps of (a) extracting date data from a date field of the check, and (b) validating the extracted date data to determine if the extracted date data is representative of a date which is prior to a predetermined date and thereby to determine if the date data in the date field of the check is representative of a date which is stale. Step (b) may comprise the step of (b-1) comparing the extracted date data with date data which is representative of the predetermined date.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a schematic block diagram representation of an image-based check processing system which embodies the present invention;

FIG. 2 is a schematic block representation of a portion of FIG. 1;

FIG. 3 is a schematic block representation of a portion of FIG. 2;

FIG. 4 is an image of a typical personal check which may be processed in accordance with the present invention;

FIG. 5 is an image of a typical business check which may be processed in accordance with the present invention;

FIG. 6 is a flowchart depicting a program for processing check image data associated with a personal check to extract date data therefrom; and

FIG. 7 is a flowchart depicting a program for processing check image data associated with a business check to extract date data therefrom;

FIG. 8 is a flowchart depicting a program for validating date data associated with either a personal check or a business check;

FIG. 9 is a schematic block representation of a bank teller station which embodies the present invention; and

FIG. 10 is a schematic block representation of an automated teller machine (ATM) which embodies the present invention.

### DETAILS OF THE INVENTION

The present invention is directed to a method of processing a check and an apparatus therefor. The check may be of any type, such as a check of the personal type or a check of the business type.

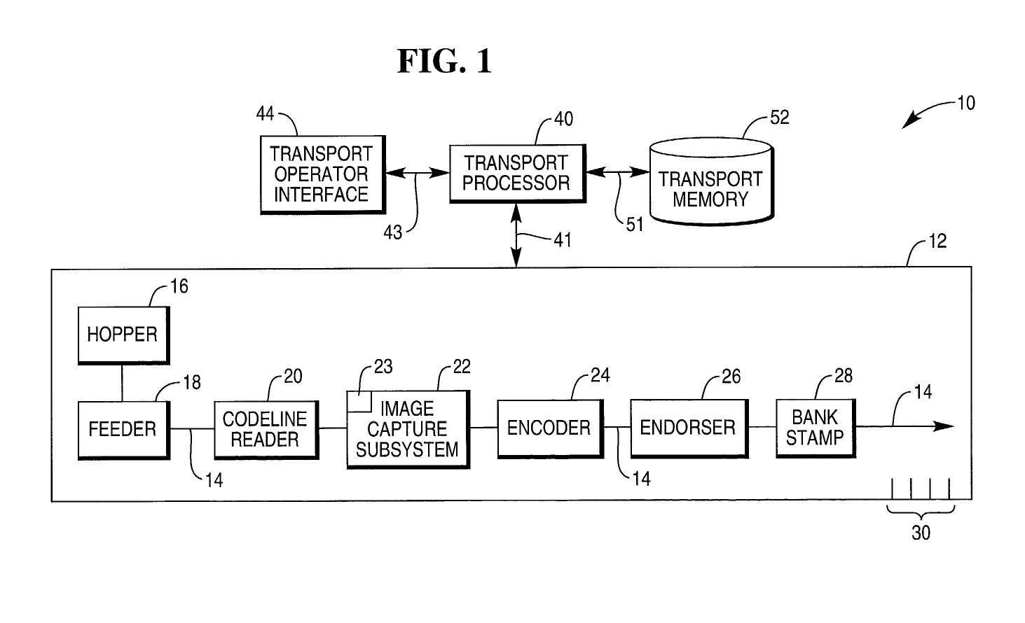

Referring to FIG. 1, an image-based check processing system 10 includes a check processing transport 12 at which images of checks are captured. The transport 12 has a document track which defines a document transport path 14 along which financial documents, such as checks, can be transported from an upstream end to a downstream end. The transport 12 includes a number of different hardware devices lying along the document transport path 14 for performing specific document processing operations on documents moving along the document transport path 14. The transport 12 includes a hopper 16 into which a stack of financial documents including checks are placed. A document feeder 18 adjacent the hopper 16 selectively feeds or drives each document from the stack of documents in the hopper to transport the document from the upstream end to the downstream end along the document transport path 14 to sorting bins 30 located at the end of the document transport path.

The check processing system 10 further includes a codeline reader 20 such as a MICR reader located along the document transport path 14. The MICR reader 20 reads a MICR codeline from each check being processed in a known manner. Alternatively, the codeline reader may be an OCR reader instead of a MICR reader depending upon on the particular application.

The check processing system 10 further includes an image capture subsystem 22 located along the document transport path 14. The image capture subsystem 22 captures an image of each document for a number of different purposes well known in the financial industry. More specifically, the image capture subsystem 22 includes a scanner 23 which is controlled to capture images of documents moving along the document transport path 14. Scanners for lifting images of checks at the check processing transport 16 are readily available in the marketplace. Their structure and operation are well known and, therefore, will not be described.

The scanner 23 lifts an image of a check as the check moves past the scanner. In particular, the scanner 23 produces pixels each pixel having a particular gray level associated therewith. The gray level of each pixel is thresholded in a known manner to provide binarized-image data. Accordingly, check image data associated with a particular check is initially captured at the check processing transport 16 and is then processed to provide binarized image data. The process of capturing an image of a check and providing binarized image data is known and, therefore, will not be described. The binarized image data associated with all of the pixels form a binarized image of the particular check.

Although the above description describes obtaining binarized image data to form a binarized image of the particular check, it is contemplated that gray scale image data may be obtained to form a gray scale image of the particular check. Alternatively, color image data may be obtained to form a color image of the particular check. Any of these types of check images may be processed in accordance with the present invention. For simplicity, only binarized images of checks will be discussed hereinafter.

An encoder 24 encodes missing fields on each check. An endorser 26 applies an endorsement in a known manner to each check. A bank stamp 28 stamps each check to identify the bank institution processing the check. The structure and operation of MICR readers, OCR readers, imaging cameras, encoders, endorsers, and bank stamps are well known and, therefore, will not be described.

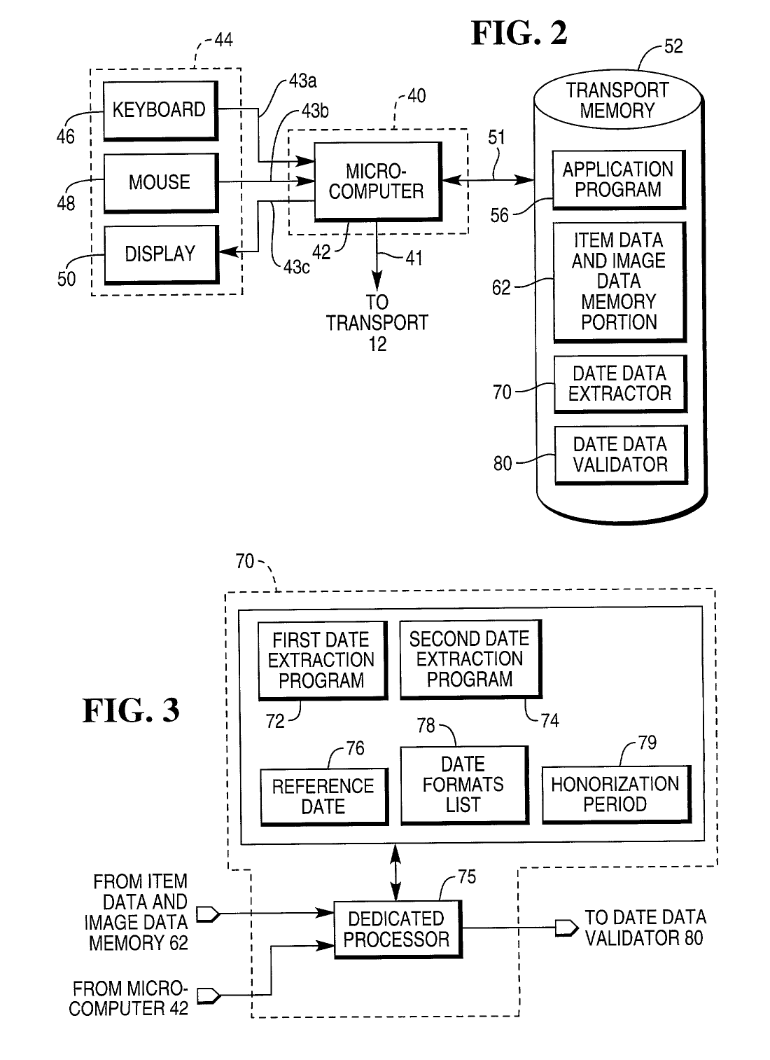

Referring to FIGS. 1 and 2, the check processing system 10 further includes a transport processor 40 and a transport operator interface 44 which communicates via signals on line 43 (FIG. 1) with a microcomputer 42 of the transport processor 40. The transport operator interface 44 includes a keyboard 46, a mouse 48, and a display 50, all of which communicate via signals on lines 43a, 43b, 43c (FIG. 2) with the microcomputer 42. The microcomputer 42 controls operation of the transport 12 via signals on line 41. Suitable microcomputers and memories are readily available in the marketplace. Their structure and operation are well known and, therefore, will not be described.

The check processing system 10 also includes a transport memory 52 which communicates via signals on line 51 with the microcomputer 42. It is contemplated that the transport memory 52 could be a single memory unit or a plurality of different memory units. An executable transport application program 56 is stored in the transport memory 52. The transport application program 56 is associated with a particular type of document processing work. For example, one type of work is proof of deposit. Another type of work is remittance processing. Still another type of work may be sorting of items. When the transport application program 56 is executed, the hardware devices lying along the document transport path 14 are controlled to process items moving downstream along the document transport path 14 in accordance with the transport application program, as is known.

The transport memory 52 includes an item data and image data memory portion 58 which stores sequence numbers, MICR codelines, image data such as the binarized image data described hereinabove, encoder status, endorsement status, and bank stamp status associated with transaction items which have been processed in accordance with the transport application program 56.

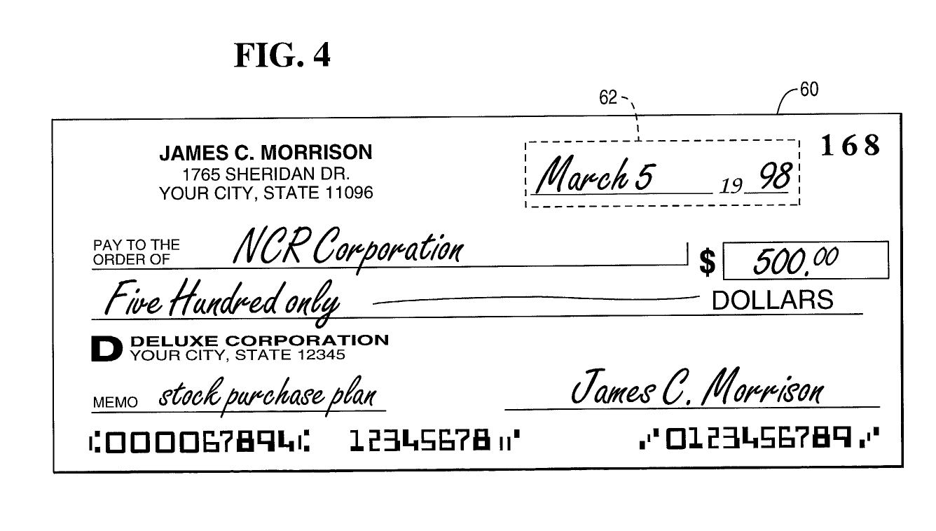

Referring to FIGS. 2 and 3, the transport memory 52 further includes a date data extractor 70. The date data extractor 70 includes a dedicated processor 75 which retrieves binarized image data from one part of the memory portion 58, processes the retrieved data to provide extracted date data. The extracted date data is stored in another part of the memory portion 58. The transport operator interface 44 allows a transport operator to control operation of the dedicated processor 75 and thereby to control processing of binarized image data stored in the memory portion 58 to extract date data therefrom.

As shown in FIG. 3, the date data extractor 70 includes a first date extraction program 72 and/or a second date extraction program 74. The date data extractor 70 also includes a reference date 76, a date formats list 78, and a honorization period 79. Preferably, the reference date 76 is today's date. However, the reference data 76 may be changed by the transport operator at any time. The date formats list 78 contains a set of user-defined date formats which vary from region to region, for example. The set of date formats contained in the date formats list 78 may be changed by the transport operator at any time. The honorization period 79 is the period of time from the date of a check during which the check may be cashed. For example, this period of time may be three months. In this example, the check may be cashed anytime from the date of the check until three months after the date of the check.

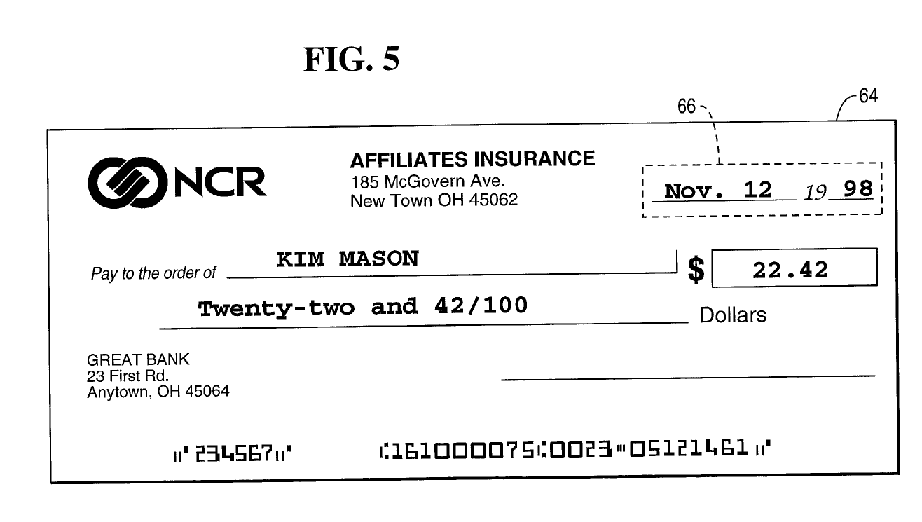

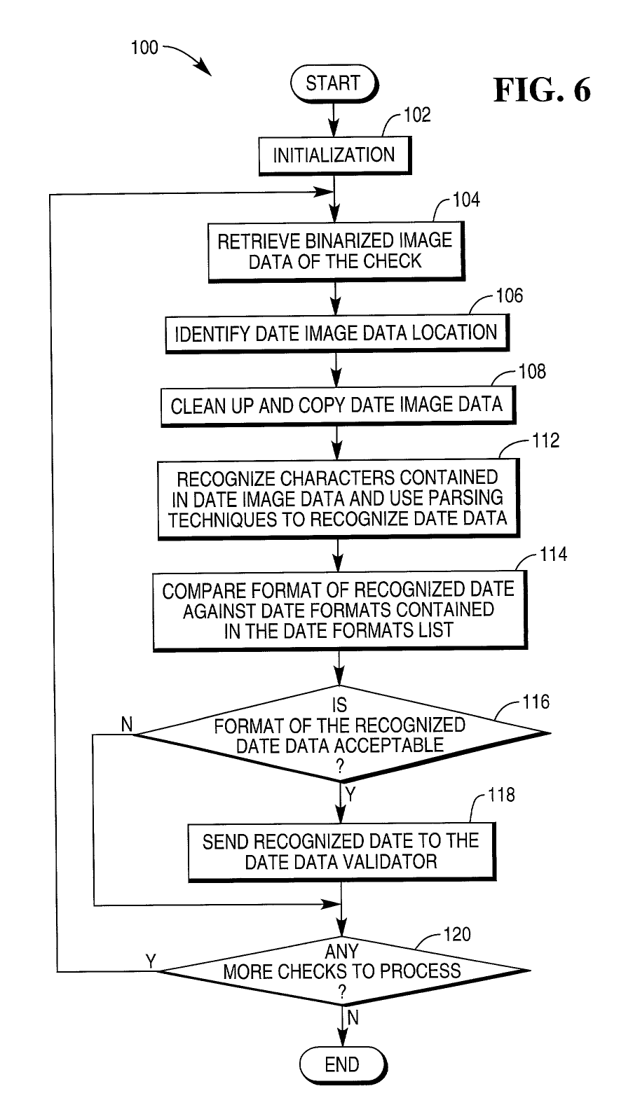

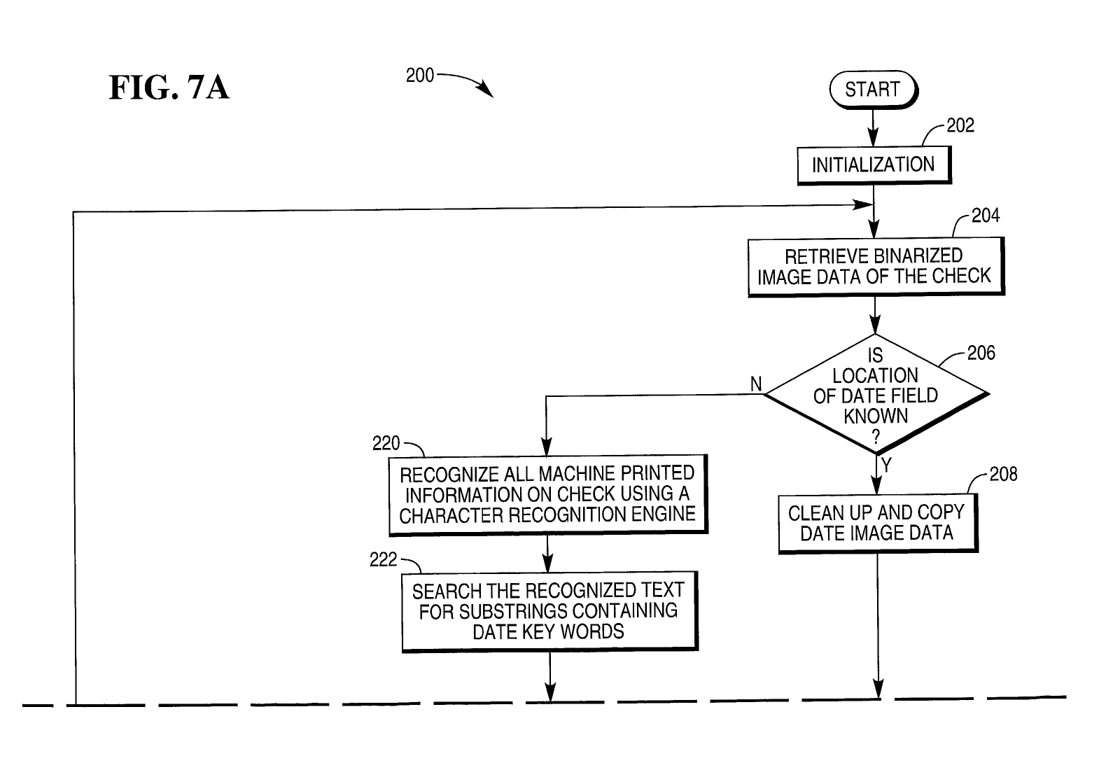

Different types of checks may be processed in accordance with the present invention. As an example, a personal check 60 having a date field 62, as shown in FIG. 4, may be processed to extract date data therefrom. Alternatively, a business check 64 having a date field 66, as shown in FIG. 5, may be processed to extract date data and then to validate the extracted date data therefrom Referring to FIG. 6, a flowchart 100 depicts steps of the first date extraction program 72 for processing binarized image data associated with the personal check 60 of FIG. 4 to extract date data therefrom. After program initialization as shown in step 102, the program proceeds to step 104 in which binarized image data associated with the check 60 is retrieved from the memory portion 58. The program then proceeds to step 106 in which the exact location of the date data contained in the date field 62 is identified for further processing.

After the date data contained in the date field 62 has been located in step 106, the program proceeds to step 108 in which the date data contained in the date field 62 is cleaned up using known image processing techniques and copied into memory for further processing. The program then proceeds to step 112 in which the date data associated with the check 60 is subjected to a handwriting recognition engine to establish the date of the check. There are many handwriting recognition engines available in the marketplace which can be used to establish the date of the check 60 and, therefore, will not be described.

Parsing techniques using the date formats list 78 are applied along with the recognition engine to establish the date of the check 60. A number of parsing techniques is well known and, therefore, will not be described. Examples of date formats for the twenty-third day of the eleventh month of the year 1999 include “11/23/99”, “November 23, 1999”, “11-23-99”, “23-11-1999”, and “23/11/99”. Then, in steps 114 and 116, the format of the recognized date from step 112 is compared with date formats contained in the date formats list 78 to determine if the format of the recognized date is acceptable.

If the determination in step 116 is negative, the program proceeds directly to step 120. However, if the determination in step 116 is affirmative, the program proceeds to step 118 in which the recognized date associated with the check 60 is sent to the date data validator 80 for further processing as will be described in detail hereinbelow. The program then proceeds to step 120 in which a determination is made as to whether there are more checks to be processed. If the determination in step 120 is affirmative, the program returns to step 104 to retrieve binarized image data associated with the next check. Otherwise, the program terminates.

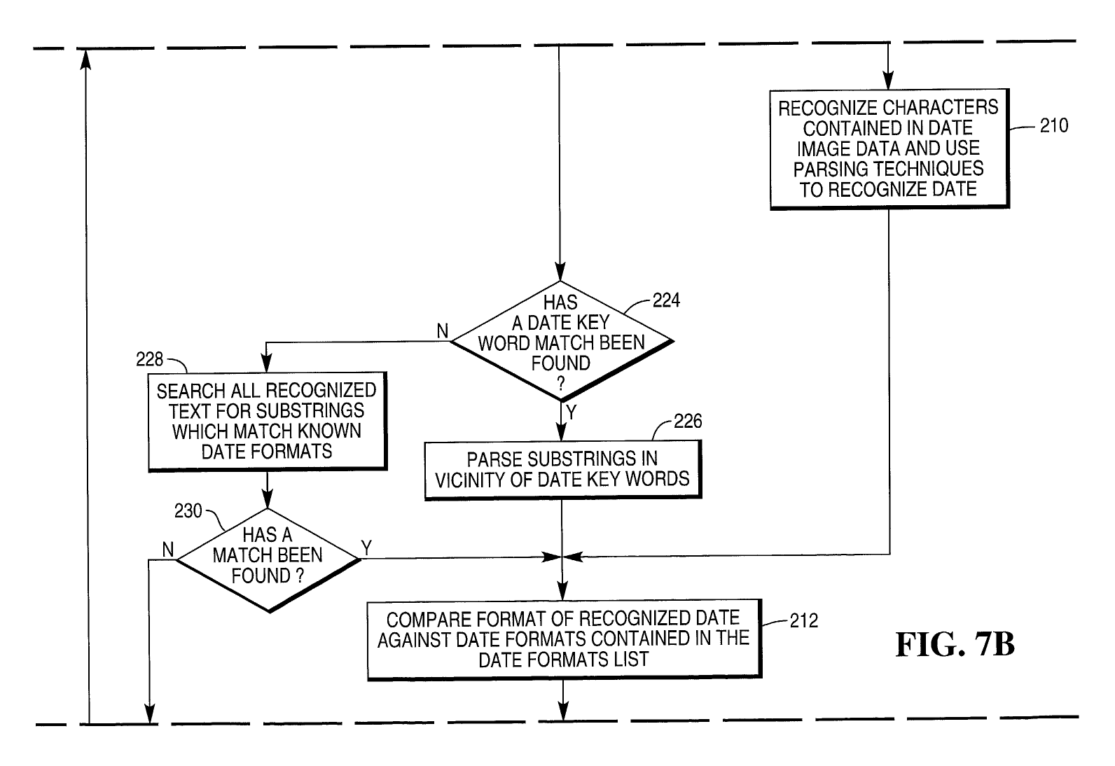

Referring to FIG. 7, a flowchart 200 depicts steps of the second date extraction program 74 for processing binarized image data associated with the business check 64 of FIG. 5 to extract date data therefrom. After program initialization as shown in step 202, the program proceeds to step 204 in which binarized image data associated with the check 64 is retrieved from the memory portion 58. The program then proceeds to step 206 in which a determination is made as to whether the location of the date field is known. If the determination in step 206 is affirmative, the program proceeds to step 208 in which the date data contained in the date field 66 is cleaned up using known image processing techniques and copied into memory for further processing. Then, in step 210, the date data is subjected to a machine-print character recognition engine to establish the date of the check 64. Parsing techniques using the date formats list 78 are applied along with the recognition engine to establish the date of the check 64. There are many machine-print character recognition engines available in the marketplace which can be used to establish the date of the check 64 and, therefore, will not be described. The program then proceeds to step 212.

However, if the determination in step 206 is negative, the program proceeds to step 220 in which all machine-printed information on the check 64 is recognized using a known machine-print character recognition engine. Then, in step 222, the recognized text from step 220 is searched for any substrings which contain key words related to dates. Key words related to dates include “Date”, “Payable Date”, “February”, and “October”, for examples. The program proceeds to step 224 in which a determination is made as to whether a key word related to dates has been found in step 222. If the determination in step 224 is affirmative, the program proceeds to step 226. In step 226, the substrings found in the vicinity of the date key words found in step 222 are parsed. The program then proceeds to step 212. If the determination in step 224 is negative, the program proceeds to step 228.

In step 228, the recognized text from step 220 is searched for any substrings which match known date formats contained in the date formats list 78. A determination is then made in step 230 as to whether a match has been found in step 228. If the determination in step 230 is negative, the program proceeds directly to step 218. However, if the determination in step 230 is affirmative, the program proceeds to step 212.

In step 212, the format of the recognized date from step 210, step 226, or step 230 is compared with date formats contained in the date formats list 78 to determine if the format of the recognized date is acceptable, as shown in step 214. If the determination in step 214 is negative, the program proceeds directly to step 218. However, if the determination in step 214 is affirmative, the program proceeds to step 216 in which the recognized date associated with the check 64 is sent to the date data validator 80 for further processing as will be described in detail hereinbelow. The program then proceeds to step 218 in which a determination as to whether there are more checks to be processed. If the determination in step 218 is affirmative, the program returns to step 204 to retrieve binarized image data associated with the next check. Otherwise, the program terminates.

It should be apparent that each of the first and second date extraction programs 72, 74 processes binarized image data stored in the memory portion 58 to provide extracted date data which is representative of the date contained in the date field of a check.

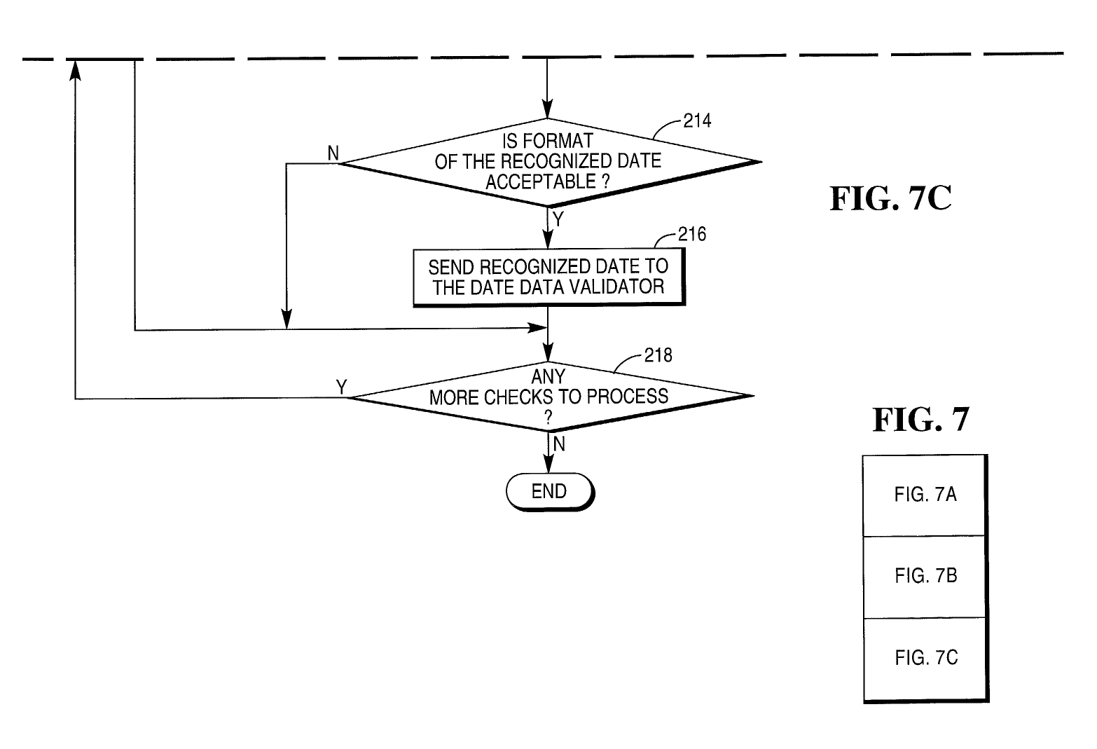

After the date data has been extracted from the date field of the check, a date data validation process is initiated. The date data validation process including operation of the date data validator 80 is described in detail hereinbelow. FIG. 8 is a flowchart 300 which depicts operation of the date data validator 80 which is initiated after the date data has been extracted from the date field of the check. In step 302, the date data which has been extracted from the date field of the check is received. In step 304, the honorization period 79 is retrieved. Then, in step 306, the retrieved honorization period 79 is added to the extracted date data.

A determination is made in step 308 as to whether the result of step 306 is older than the reference date 76. If the determination in step 308 is negative, then the check is deemed to have a non-stale date and is accepted, as shown in step 310. However, if the determination in step 308 is affirmative, then the check is deemed to have a stale date and is rejected, as shown in step 312.

Although the above description shows the honorization period 79 as being three months, it is contemplated that this period may be any amount of time. For examples, the honorization period could have been one month, ninety days, six months, or one year. It is also contemplated that there are numerous other ways of determining the result of step 306 and comparing this result in step 308 for the purpose of determining whether the check has a stale date. For example, the honorization period 79 could have been subtracted from the reference date 76, and then a determination made as to whether the extracted date data of the check is older than this result.

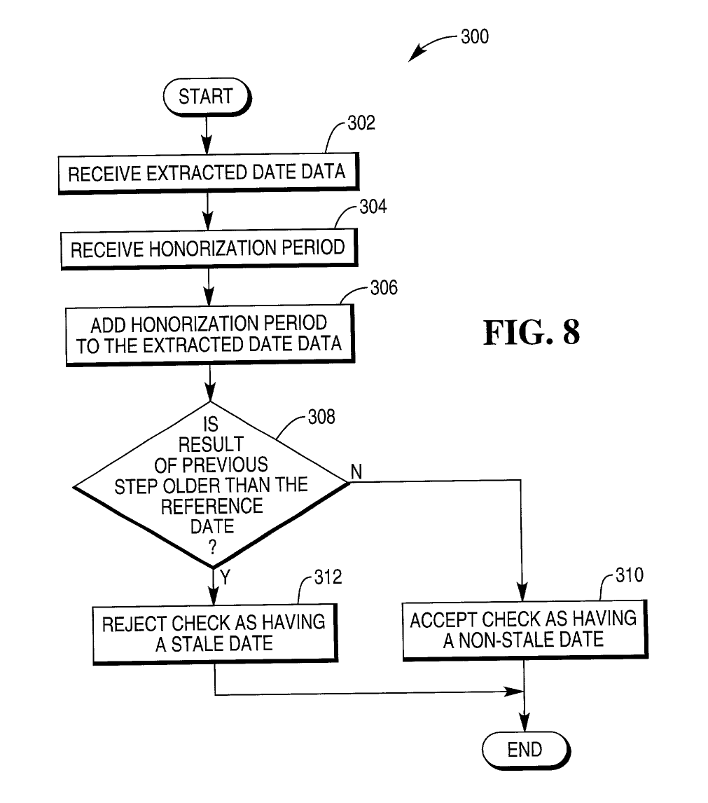

Also, although the above example describes one type of system in which the present invention is embodied, there are other types of systems, and the like, in which the present invention may also be embodied. For example, as shown in FIG. 9, the present invention is embodied in a bank teller station 400. The bank teller station 400 includes a document transport mechanism 402 which receives documents which are hand-dropped into a document transport path by a bank teller. An image capture subsystem 404 captures images of the documents. A bank teller station processor 406 connected in communication with a bank teller station memory 408 processes the captured images from the image capture subsystem 404. The image capture subsystem 404, the bank teller station processor 406, and the bank teller station memory 408 cooperate together in a manner similar to the image capture subsystem 22, the transport processor 40, and the transport memory 52, as described hereinabove in the embodiment of FIGS. 1-8.

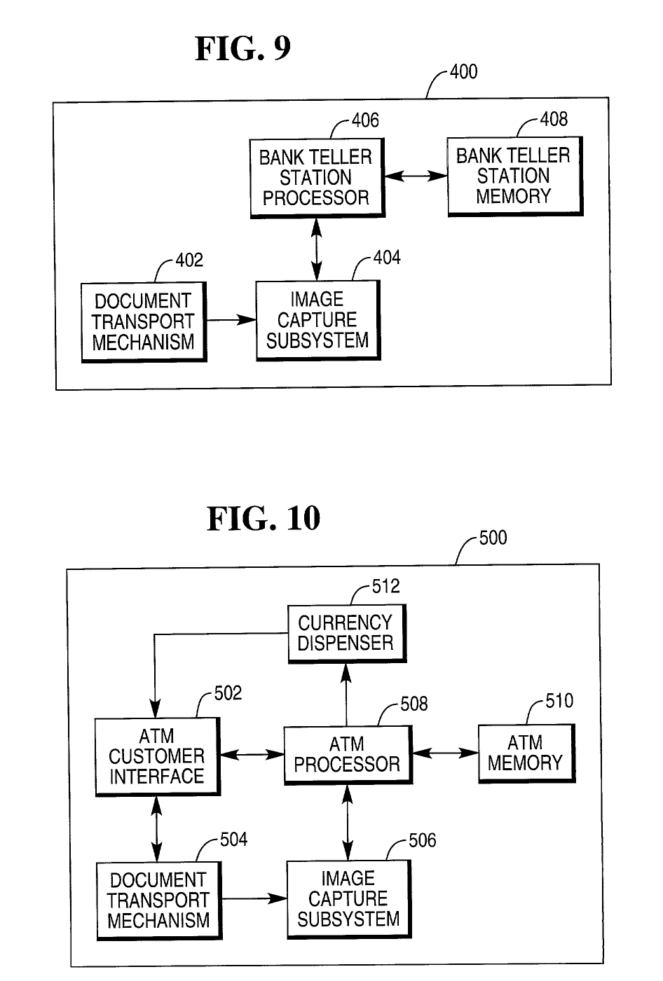

As another example, as shown in FIG. 10, the present invention is embodied in an automated teller machine (ATM) 500. The ATM 50 includes an ATM customer interface 502 which receives documents from an ATM customer. A document transport mechanism 502 receives the documents from the ATM customer. An image capture subsystem 506 captures images of the documents. An ATM processor 508 connected in communication with an ATM memory 510 processes the captured images from the image capture subsystem 506. The image capture subsystem 506, the ATM processor 508, and the ATM memory 510 cooperate together in a manner similar to the image capture subsystem 22, the transport processor 40, and the transport memory 52, as described hereinabove in the embodiment of FIGS. 1-8. The ATM processor 508 also controls a currency dispenser 512 which delivers currency to the ATM customer via the ATM customer interface 502.

A number of advantages result by providing a method of processing a check in accordance with the present invention as described. One advantage is that checks with stale dates are identified without human intervention. This results in higher productivity of human operators such as transport operators and bank tellers. This also results in a cost savings since bank personnel are not required to handle stale checks. Also, less training of operators is needed. Another advantage is that the chance of failing to identify a check having a stale date is reduced.

It is contemplated that the above-described programs including the date data extractor 70 and the date data validator 80 be available on portable storage media, such as a compact disc read only memory (CDROM)). The programs on a CDROM may be installed on different types of financial document processing systems to provide these systems with corresponding capabilities as described above. It is also contemplated that the date validation process described above may be used in other types of financial document processing systems, such as non-image-based systems, for example.

From the above description of the invention, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A method of processing a check without human intervention to determine if the check has a stale date, the method comprising the steps of:
(a) extracting date data from a date field of the check; and
(b) validating the extracted date data to determine if the extracted date data is representative of a date which is prior to a predetermined date and thereby to determine if the date data in the date field of the check is representative of a date which is stale.

2. A method according to claim 1, wherein step (b) includes the step of:
(b-1) comparing the extracted date data with date data which is representative of the predetermined date.

3. A check processing apparatus comprising:
means for extracting date data from a date field of a check; and
means for validating the extracted date data to determine if the extracted date data is representative of a date which is prior to a predetermined date and thereby to determine if the date data in the date field of the check is representative of a date which is stale.

4. An apparatus according to claim 3, wherein the validating means includes means for comparing the extracted date data with date data which is representative of the predetermined date.

5. An apparatus according to claim 3, further comprising a check processing transport including an image capture subsystem for capturing images of checks.

6. An apparatus according to claim 3, further comprising a document transport mechanism for receiving checks hand dropped by a bank teller at a bank teller station.

7. An apparatus according to claim 3, further comprising a cash dispenser for dispensing cash to a customer of an automated teller machine.

8. A program storage medium readable by a computer having a memory, the medium tangibly embodying one or more programs of instructions executable by the computer to perform method steps for processing a check to determine if the check has a stale date, the method comprising the steps of:
(a) extracting date data from a date field of the check; and
(b) validating the extracted date data to determine if the extracted date data is representative of a date which is prior to a predetermined date and thereby to determine if the date data in the date field of the check is representative of a date which is stale.

9. A program storage medium according to claim 8, wherein step (b) includes the step of:
(b-1) comparing the extracted date data with date data which is representative of the predetermined date.
